(19) United States
(12) Patent Application Publication
(10) Pub. No.: US 2012/0060155 A1
(43) Pub. Date: Mar. 8, 2012

(54) METHOD, SYSTEM, AND COMPUTER READABLE MEDIUM FOR WORKFLOW COMMUNICATION WHEREIN INSTRUCTIONS TO A WORKFLOW APPLICATION ARE WRITTEN BY THE WORKFLOW APPLICATION

(76) Inventor: Gregory C. Keys, Warwick, NY (US)

(21) Appl. No.: 12/874,375

(22) Filed: Sep. 2, 2010

(51) Int. Cl. G06F 9/46

(52) U.S. Cl. 718/100; 712/220; 712/E09.003

(57) ABSTRACT

A method, apparatus, system, and computer readable medium for communicating between an apparatus hosting a workflow application and a device, by generating a template including a placeholder. The instruction template is then sent to the device and a device output is received from the device, the device output including device data generated by the device and inserted into the placeholder of the template.

### CROSS-REFERENCE TO RELATED APPLICATIONS

The present application is related to U.S. patent application Ser. No. ______, Attorney Docket No. 350272US, filed ______, and U.S. patent application Ser. No. 12/853,910, filed Aug. 10, 2010, the entire subject matter of which are incorporated herein by reference.

### BACKGROUND

1. Field of the Invention

The present disclosure relates to workflow communication between a device and a workflow application.

2. Description of the Related Art

A “workflow” generally relates to an automated process during which information, usually in the form of documents, or tasks are communicated from one participant to another, based on some trigger, for their action set forth by a set of procedural rules. A “workflow application” is a computer software or online-based program that is used to more efficiently manage all or part of a process that would otherwise not be automated. A process is usually business-related, but it may be any process that requires a series of steps that can be automated via software. Some steps of the process may require human intervention, such as an approval or the development of custom text, but functions that can be automated may be handled by the application.

A workflow application may require instructions or data from a participating device completing a particular workflow step. These instructions may carry data produced by the device during the workflow step, or data passed by the workflow before the workflow step. These instructions may be selected by a device from a set of possible selections, depending on inputs to, conditions of, or outputs of the device. Conventionally, a device may not be able to participate in a workflow because it is unable to generate instructions in a language protocol or format that workflow requires from the device. A device may not be able to generate the aforementioned instructions because the device does not have the processing power, the device is not aware of the required language protocol or format, the device cannot generate instructions in the language format required by the workflow application, or the device does not hold workflow or data logic, or both, required to generate the instruction.

Furthermore, a workflow application may involve changes to instructions at the application level and such changes may only be made on the workflow application, and not on each of the participating devices. The workflow application may involve changes to instructions at the application level for reasons including that the application logic may change and thus instructions may change, or that instructions may be written in a standardized language (i.e., Simple Object Access Protocol (SOAP)) and specifications for this language may change (i.e., SOAP 1.1 changing to SOAP 1.2). These changes can be made on the workflow application, thus avoiding the making of changes on each of a plurality of devices.

Conventionally, it may be costly, time consuming, and error-prone to update each device to allow each to generate changed instructions at the application level.

### SUMMARY

In order to allow a device to participate in a workflow, or to avoid making changes on each of a plurality of participating devices, changes may be made on the workflow application itself, thereby allowing a plurality of devices to participate in a workflow application.

The present disclosure describes a method, apparatus, system, and computer readable medium for communicating between an apparatus hosting a workflow application and a device, by generating a template including a placeholder. The instruction template is then sent to the device and a device output is received from the device, the device output including device data generated by the device and inserted into the placeholder of the template.

As should be apparent, a number of advantageous features and benefits are available by way of the disclosed embodiments and extensions thereof. It is to be understood that any embodiment can be constructed to include one or more features or benefits of embodiments disclosed herein, but not others. Accordingly, it is to be understood that the embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 shows an embodiment of the present disclosure;

FIG. 2 shows a communication between a device and a workflow application;

FIG. 3 is a flow diagram of the embodiment of FIG. 2; and

FIG. 4 illustrates a computer system upon which an embodiment of the present disclosure may be implemented.

### DETAILED DESCRIPTION

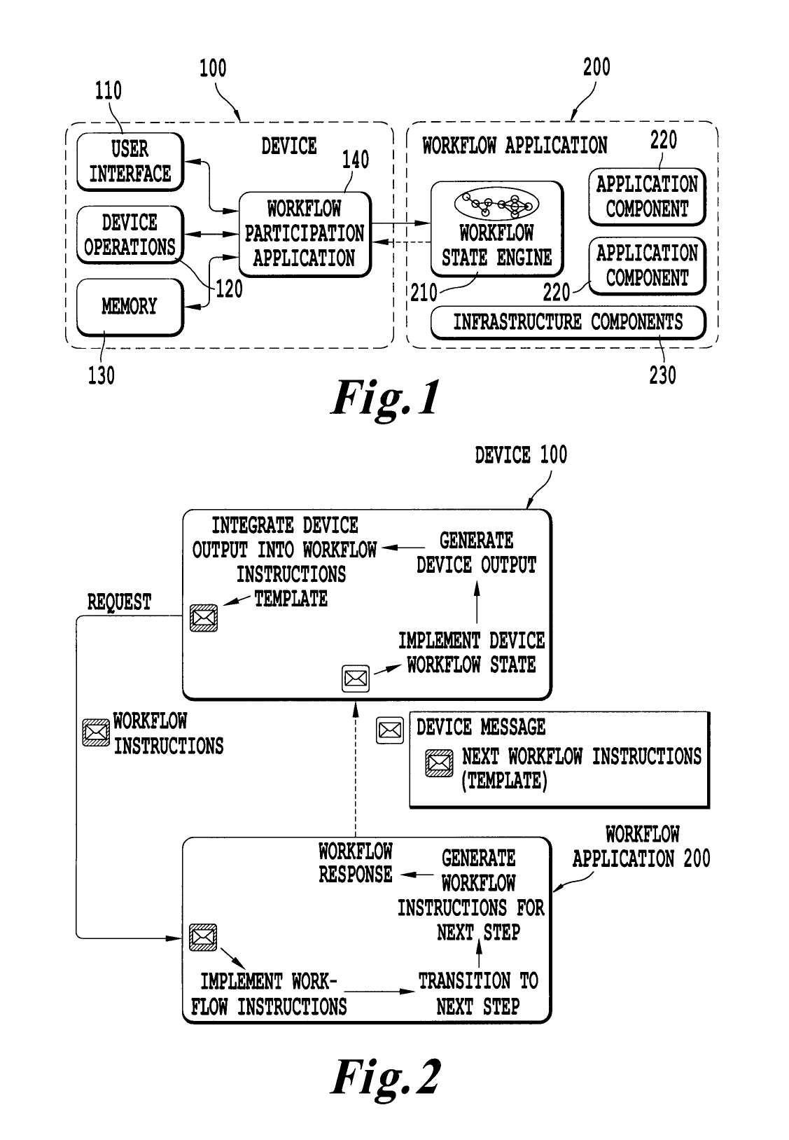

FIG. 1 shows device 100 components and workflow application 200 components of an embodiment of the present disclosure. A device 100 may include, for example, a user interface 110, device operation(s) 120 or capabilities, a memory 130, and a workflow participation application 140. The device 100 may communicate with the workflow application 200 through a physical or wireless connection, without requiring a specific communication protocol (i.e., Hypertext Transfer Protocol (HTTP)), or a specific messaging model (i.e., client-server, asynchronous messaging, or the like). The communication is generally performed between the device's workflow participation component 140 and the workflow application's workflow state engine 210. Furthermore, as explained below, the communication may be triggered by an event, such as an input by a user on the user interface 110 or the like.

The workflow application 200 may include a workflow state engine 210, application component(s) 220, and infrastructure component(s) 230. The workflow state engine 210 manages state and state transitions of the workflow application 200, and communicates with other workflow applications (i.e., databases, file systems, user directories, third party components such as credit rating services, banking systems, or the like). The workflow application 200 components may be hosted on the same host (i.e., a single server, a personal computer (PC), or the like), or may be distributed across a network (i.e., an enterprise network) at various positions in relation to firewalls, subnets, or the like.

A device's workflow participation application component 140 communicates with a workflow state engine component 210, of the workflow application 200, by way of a communication component. The device's workflow participation application component 140 communicates with a device's user interface 110, device's operation(s) 120, and a device's memory 130. In one embodiment, either a user interface 110 or operation(s) 120 may be present. In another embodiment, both the user interface 110 and the device's operation(s) 120 may be present. When both are present in a device, the user interface 110 and device operation(s) 120 may communicate. A device's user interface 110 allows user input to a device. Any type of input (i.e., text, voice, chemical, biometric, or the like) may be used with the various embodiments of the present disclosure.

Device operation(s) 120 allow(s) non-user inputs into and outputs out of a system and internal triggers of a system. Such operations may be device-specific. For example, input may be chemical (i.e., blood sample, environmental atmosphere sample, radiation level, or the like). Output examples may include sound (i.e., alarms, machine-generated human voice, printed documents, or the like). Internal trigger examples may include response to device energy level, device supply level (i.e., toner level of copy machine, or the like), device diagnostics, or the like.

After a workflow step is completed on the device 100, the workflow participation component 140 sends instructions to the workflow application 200 without needing to know the content of the instructions, or the language protocol or format from which these instructions are constructed. This occurs by the workflow application 200 first sending a template of those instructions to the device 100. These instructions will be modified and returned to the workflow application 200 after the device 100 completes its workflow step. The workflow participation component 140 on the device 100 may only need to know how to modify the template by replacing placeholders on the template with data resulting from the completed workflow step. The mechanism logic of replacing placeholders with data values is specified before the workflow application 200 is developed and implemented. Software on the device 100 and workflow application 200 sides are written to incorporate this logic.

The workflow application 200 thus becomes responsible for generating the instructions it will receive after the device 100 completes the workflow step. For example, many workflows use Simple Object Access Protocol (SOAP) messaging as a language protocol by which to communicate workflow steps between a device client and a workflow or business process application. A workflow application 200 of the present disclosure would send a SOAP message to the device 100, which the device 100 uses to complete a workflow step. Inside this SOAP message to the device 100 may be the device's subsequent SOAP message to the workflow application 200 with placeholders that the device 100 replaces with data values, generated by the device 100 itself when completing the workflow step. After replacing these values, the device 100 sends this SOAP message to the workflow application 200, with the device 100 knowing only, for example, the mechanism of replacing placeholders with data values and knowing nothing, for example, about the SOAP requirements or content of the message. The placeholder mechanism includes a mechanism to identify the beginning and end of the template that will be modified with data values and sent to the workflow applciation 200.

Additionally, it should be noted that this placeholder replacement and template identification mechanism may be applied identically to multiple language protocols and formats. For example, the workflow application 200 may change from SOAP 1.1 to SOAP 1.2, or SOAP 1.1 to a simple format of name-value pairs, while using the same placeholder replacement and template identification mechanism before and after the change. Such a change is done with no disruption to, or changes required, on the device 100.

Device memory 130 is used by the device's workflow participation component 140, just as any software application would use memory.

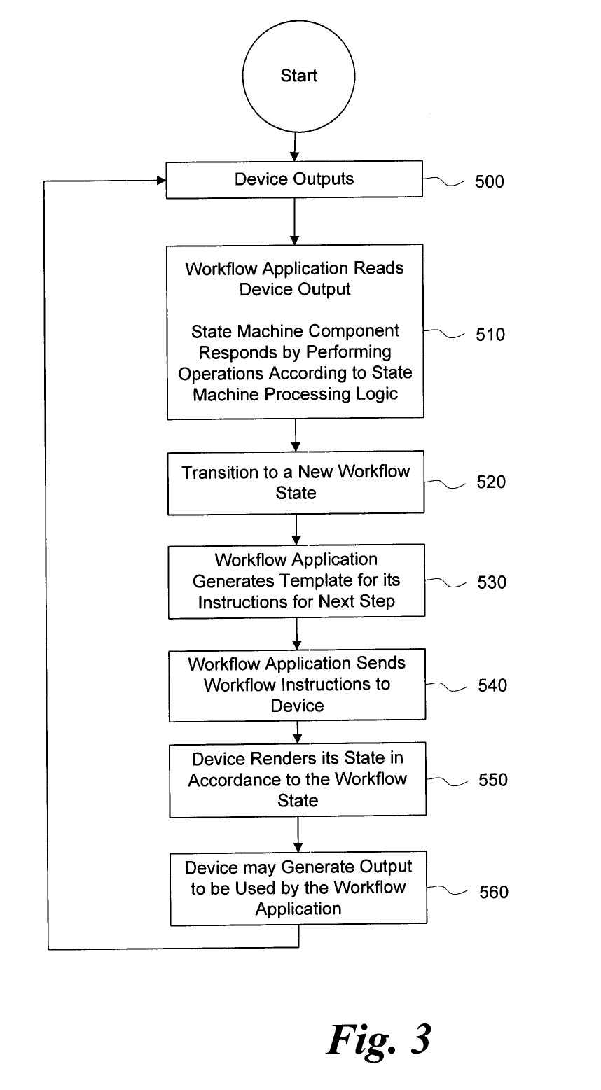

FIG. 2 shows the communication between a device 100 and a workflow application 200. FIG. 3 is a flow diagram outlining the steps of the communication between the device 100 and the workflow application 200 of FIG. 2.

First, a device 100 outputs (step 500), and the output is received by the workflow application 200. Such an output may be a request for workflow instructions, an output generated by a previous iteration of the succeeding steps, or information entered by a user via the user interface 110. Next, in step 510, the workflow application 200 reads the device output. The state machine component 210 of the workflow application 200 responds by performing operations according to the state machine processing logic. In step 520, the result of the operations performed by the state machine processing logic 210 transitions the process to a new workflow state.

In step 530, the workflow application 200 generates a template for its instructions for the next step of the process. This step may include, but is not limited to, the possibility of integrating device output into the generated instructions, or a plurality of instructions, each mapped to a particular user interface component 110 of the device 100 (i.e., different buttons on the device user interface 110 may be associated with different workflow instructions of the workflow application 200).

In step 540, the next workflow instructions are sent to the device 100. Once the device 100 receives the next workflow instructions, the device 100, in step 550, renders its state in accordance to the particular workflow state it is in. The device 100 then, in step 560, may generate output that may be used by the workflow application 200. The rendering of the state may be accomplished either via a generic software programming which responds to the instructions sent to it, or through the above-identified application incorporated herein by reference. Additionally, it may be that some, or all, steps do not result in the device 100 generating output. If output is indeed generated, it is incorporated into the workflow instructions and sent back to the workflow application 200.

As noted above, a workflow application 200 generates instructions that can be used by itself to transition to the next workflow state. These instructions do not need to be readable or interpreted by the device 100. However, the instructions are to be readable and interpretable by the workflow application 200. Such instructions may involve a set of instructions. This set of instructions may be sent to a device 100, and the device 100 may select one of the sets to send back to the workflow application 200. The selection may depend upon an input to the device 100, a condition of the device 100, or an output of the device 100.

The generated instructions are used by the workflow application 200 after a device 100 participates in the workflow. These instructions are sent to one or more device(s) that may participate in the workflow. The instructions may or may not involve outputs from the device 100 after it participates in the workflow. When such a device 100 participates in the workflow step, it sends the instructions to the workflow application 200. When the workflow application 200 receives these instructions, the workflow application 200 processes the instructions. After processing the instructions, a new workflow step is reached, and the sequence may be repeated depending on the number of instructions. When the workflow application 200 transitions to a new step that a device 100 may participate in, the workflow application 200 sends the instructions to that device 100. If the instructions involve device outputs, the device 100 incorporates its output into the instructions before sending both the output and the instructions to the workflow application 200.

Therefore, the workflow of the present disclosure need not know any information about how a device carries information, because the workflow application itself generates the message which it will subsequently receive. Accordingly, a device may participate with any workflow application as long as the workflow application generates instructions itself in its own form and sends them to the device which, in turn, sends it back to the workflow application.

As an example, business processes or workflow applications commonly use a messaging protocol called Simple Object Access Protocol (SOAP). Messages between clients (i.e., devices, personal computers (PCs), or the like) and business processes or workflow applications must conform to the SOAP protocol. There may be many reasons why a client does not communicate using SOAP. For example, the protocol is very complex and difficult to conform to, small devices may not be able to generate SOAP messages due to the relatively large amount of computing power required to do so, or the device may not be able to use third-party software that generates and processes SOAP messages. Therefore, clients that do not implement SOAP cannot participate in the business process or workflow application.

However, any client implementing the features of the present disclosure may participate in business processes or workflow applications requiring SOAP messaging, because the workflow application writes the SOAP-compliant message that the workflow application will consume when the device outputs it back to the workflow application. The device simply integrates its output into the message and returns the pre-generated message to the workflow application. The present disclosure also allows client-workflow applications that are using a specific messaging protocol (e.g., industry-specific SOAP) to change that protocol to a protocol defined by the workflow application, for example, with no changes made to each of the clients. Otherwise, each client would need new software versions that implement the new messaging protocol. This is advantageous because clients participating in business processes or workflow applications often comprise thousands of units and are dispersed over large geographic areas.

In a second example, there may be a device, Device A, and two workflow applications, Application A and Application B. The workflow state engine of Application A may run executable files inside of it. The workflow state engine of Application B, however, may use machine readable code. In this case, the workflow participation application of Device A would have to know what type of information to send to each of Application A and Application B. However, in applying the features of the present disclosure, the workflow participation application of Device A does not need to know what type of information each of the workflow state engines of Application A and Application B can process because the workflow state engines of both applications generate the templates (tailored to each of the applications' specifications) which they will receive back from Device A.

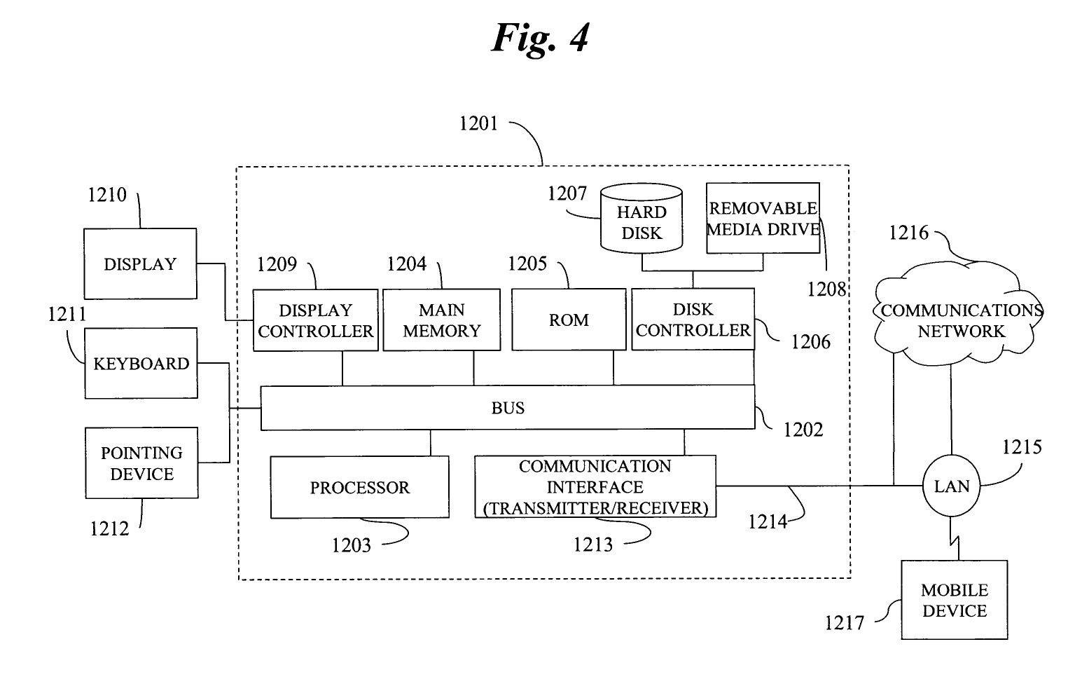

FIG. 4 illustrates a computer system 1201, device, or MFP upon which an embodiment of the present disclosure may be implemented. The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a touch panel display or a liquid crystal display (LCD), for displaying information to a computer user. The user interface 110 of FIG. 1, for example, may be displayed on the display 1210. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, other embodiments may include the use of a carrier wave (described below), or any other medium from which a computer can read. Other embodiments may include instructions according to the teachings of the present disclosure in a signal or carrier wave.

Stored on any one or on a combination of computer readable media, the present disclosure includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory. A modem local to the computer system 1201 may receive the data. The data may then be placed on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Further, it should be appreciated that the exemplary embodiments of the present disclosure are not limited to the exemplary embodiments shown and described above. While this invention has been described in conjunction with exemplary embodiments outlined above, various alternatives, modifications, variations and/or improvements, whether known or that are, or may be, presently unforeseen, may become apparent. Accordingly, the exemplary embodiments of the present disclosure, as set forth above are intended to be illustrative, not limiting. The various changes may be made without departing from the spirit and scope of the invention. Therefore, the disclosure is intended to embrace all now known or later-developed alternatives, modifications, variations and/or improvements.

1. A system for communicating between an apparatus hosting a workflow application and a device, the system comprising:
a processor, at the apparatus, configured to generate a template including a placeholder; and
an interface, at the apparatus, configured to send the template to the device and configured to receive a device output from the device, the device output including device data generated by the device and inserted into the placeholder of the template.

2. The system of claim 1, wherein the template is not in the machine-readable language of the device.

3. The system of claim 1, wherein the template is generated in the language of the workflow application.

4. The system of claim 1, wherein
the template includes sets of placeholders, and
the device is configured to select only one set of placeholders from the sets of placeholders based on at least one of an input, output, and condition of the device.

5. The system of claim 1, wherein the device is at least one of a chemical sensor, a medical device, an electrical appliance, a tablet personal computer, and a smart phone.

6. The system of claim 1, wherein the device contains a user interface which receives, as input, at least one of a text data, voice data, chemical data, and biometric data.

7. The system of claim 1, wherein the template is sent to the device as part of a message, the message including information instructing the device to generate the device data.

8. The system of claim 1, wherein
the processor, at the apparatus, is configured to generate a second template including a second placeholder; and
the interface, at the apparatus, is configured to send the second template to a second device and is configured to receive a second device output from the second device, the second device output including second device data generated by the second device and inserted into the second placeholder of the second template.

9. A method for communicating between an apparatus hosting a workflow application and a device, the method comprising:
generating, at the workflow application, an instruction template for an instruction;
sending, by the workflow application, the instruction template to the device;
receiving, by the device, the instruction template;
generating, by the device, an output;
integrating, by the device, the output into the instruction template thereby producing a completed output instruction message;
sending, by the device, the completed output instruction message;
receiving, by the workflow application, the completed output instruction message; and
processing, by the workflow application, the completed output instruction message.

10. The method of claim 9, wherein the instruction template is not in the machine-readable language of the device.

11. The method of claim 9, wherein the instruction template is generated in the language of the workflow application.

12. The method of claim 9, further comprising:
second generating, at the workflow application, a second instruction template for a second instruction;
second sending, by the workflow application, the second instruction template to a second device;
second receiving, by the second device, the second instruction template;
second generating, by the second device, a second output;
second integrating, by the second device, the second output into the second instruction template thereby producing a second completed output instruction message;
second sending, by the second device, the second completed output instruction message;
second receiving, by the workflow application, the second completed output instruction message; and
second processing, by the workflow application, the second completed output instruction message.

13. A computer-readable storage medium including computer executable instructions for communicating between an apparatus hosting a workflow application and a device, wherein the instructions, when executed by a computer, cause the computer to perform a method comprising:
generating a template including a placeholder;
sending the template to the device; and
receiving a device output from the device, the device output including device data generated by the device and inserted into the placeholder of the template.

14. The computer-readable medium of claim 13, wherein the template is not in the machine-readable language of the device.

15. The computer-readable medium of claim 13, wherein the template is generated in the language of the workflow application.

16. The computer-readable medium of claim 13, further comprising:
second generating a second template including a second placeholder;
second sending the second template to a second device; and
second receiving a second device output from the second device, the second device output including second device data generated by the second device and inserted into the second placeholder of the second template.
